(19) United States
(12) Patent Application Publication
(10) Pub. No.: US 2009/0241389 A1
(43) Pub. Date: Oct. 1, 2009

(54) ROTATABLE WHEEL ASSEMBLIES AND METHODS FOR MAKING THE SAME

(76) Inventor: Frank J. Puisis, Hinsdale, IL (US)

Correspondence Address: MCANDREWS HELD & MALLOY, LTD, 500 WEST MADISON STREET, SUITE 3400, CHICAGO, IL, 60661, US

(21) Appl. No.: 12/196,356

(22) Filed: Aug. 22, 2008

Related U.S. Application Data
(60) Provisional application No. 61/039,319, filed on Mar. 25, 2008.

(51) Int. Cl. G09F 11/04; B23P 11/02

(52) U.S. Cl. 40/495; 29/446

(57) ABSTRACT

The present technology relates to rotatable wheel assemblies and methods of making the same. Specifically, the present technology relates to rotatable wheel assemblies including a rotatable wheel enclosed in a carrier. The carrier includes a front cover member and a back cover member. The rotatable wheel may be located between the front cover member and the back cover member. At least one cover member may include an integrated hub. The wheel may be secured by and rotate about the integrated hub. At least one cover member may include a viewing window, which allows the user to view a face of the wheel.

### RELATED APPLICATIONS

This application claims priority to and benefit from U.S. provisional patent application No. 61/039,319, filed on Mar. 25, 2008, which is incorporated hereby in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Many magazines, catalogs, and books include inserts. Inserts are useful to distribute many types of information including, for example, advertisements or other descriptions about a product, service or promotion.

Publishers and advertising agencies continually seek out new designs for inserts. For example, magazine publishers and advertisers desire new technology in magazine inserts to sell to their clients. Typically, magazine insert technology falls under three different categories: dimensional, audio, and visual. “Dimensional” technology includes pop-ups and any items that have motion or moving parts. Motion could occur automatically when an insert is opened or may be imparted manually by the consumer.

One type of dimensional insert includes a rotatable wheel. The wheel may contain information, indicia, or artwork on its face. The information or indicia may be selectively viewable. In general, such inserts also include a front cover having a viewing window or opening. In operation, a rotatable wheel may be manually rotated by the user. Rotation of the wheel may selectively reveal some of the information or indicia through the viewing window of the front cover.

Many rotatable wheels are constructed with a plastic or metal grommet centered on the wheel as a hub to hold the moving surfaces of the wheel together as a unit or to adhere the wheel to a cover. Thus, many magazine inserts that include rotatable wheels are manufactured using plastic or metal grommets.

In developing specialty magazine inserts, particularly those that include rotatable wheels, consideration must be given to the types of materials that are used for the manufacture of the inserts. One downside to using plastic or metal is that these materials are not eco-friendly. That is, plastic and/or metal contaminate the paper waste that is generated in the production, binding and distribution of the magazines.

Additionally, the use of plastic or metal grommets in magazine inserts may result in a significant cost to the publisher or distributor at the disposal stage. Inserts with plastic or metal grommets are often separated from pure paper waste prior to disposal. For example, if a magazine insert with a plastic or metal grommet is destroyed during the manufacturing or binding process, it must be segregated from the other paper waste. Likewise, following collection of unsold copies of a magazine from various retailers, a distributor often separates the magazines with plastic or metal grommets from the pure paper waste. These separation procedures often result in a considerable cost to the publisher and/or distributor.

Yet another drawback of using plastic or metal in the construction of an insert is the risk that the plastic or metal piece will tear the magazine during the manufacturing and/or binding process.

Thus, the use of plastic or metal grommets presents significant disadvantages in the design and manufacture of rotatable wheels, and particularly for rotatable wheels for use as magazine inserts. One approach to circumvent the disadvantages of plastic or metal grommets has been to manufacture an insert that has a hub made of an adhesive material. For example, the Williamson Printing Company manufactures an insert that has a hub made of solid glue. Likewise, U.S. Pat. Nos. 4,323,609 and 5,374,461 disclose a rotatable wheel that is secured between two cover members and may rotate about an adhesive patch that adheres one cover member to the other cover member. Another approach has been to manufacture an insert with a paper hub or grommet.

Current grommetless wheel inserts are costly and time consuming to manufacture. Many current grommetless wheels that include a paper hub are manufactured as separate pieces; the paper hub is separate and distinct from the carrier. Therefore, affixing these paper hubs to the carrier requires a separate application step. In certain instances, affixing paper hubs to the wheel may require tedious application by hand.

Furthermore, application of a separate hub to a carrier may result in misalignment of the hub. As a result, the appropriate portion of the wheel, when situated on a misaligned hub, may not be visible to the user. For example, information, indicia, or artwork printed on the face of a wheel that sits on a misaligned hub may not be in exact registration with a viewing window.

A rotatable wheel assembly comprising a hub that is a separate and distinct feature may not have adequate durability. For example, the lifespan of a rotatable wheel assembly comprising a hub that is a separate and distinct feature is limited by the durability of the material used to affix the hub to the carrier.

Thus, there is a need to provide a rotatable wheel assembly that does not include metal or plastic grommets and provides for properly aligned registration of information, indicia, or artwork printed on the face of a wheel with a viewing window. Further there is a need to provide a rotatable wheel assembly that is easy and inexpensive to construct and may be rapidly produced on a large scale, for example, by an automated process.

The present technology generally relates to rotatable wheel assemblies. More particularly, the present technology relates to magazine or catalog inserts including a rotatable wheel. The present technology generally relates to integrated paper hubs that secure or affix a rotatable wheel to a carrier. The present technology provides eco-friendly rotatable wheel assemblies comprising an integrated hub.

### BRIEF SUMMARY OF THE INVENTION

Certain embodiments of the present technology relate to a magazine or catalog insert designed specifically for the publishing industry. The insert includes a rotatable wheel enclosed in a carrier. The insert is dimensional, interactive and designed to engage the publication reader. Readers will enjoy spinning the wheel and simultaneously learning about the advertiser's product or service.

Certain embodiments of the present technology relate to a rotatable wheel enclosed in a carrier. The carrier includes a front cover member and a back cover member. The wheel may be located between the front cover member and the back cover member. The back cover member may include a paper hub. The wheel may be secured by and rotate about the paper hub. At least one of the cover members may include at least one viewing window, which allows the user to view a face of the wheel. At least one face of the wheel may include information, indicia, or artwork that is selectively viewable through a viewing window. Where multiple viewing windows are employed, selectively viewable information, indicia, or artwork may be appropriately spaced and aligned such that each of the multiple viewing windows concurrently displays information, indicia, or artwork.

Certain embodiments of the present technology relate to a magazine insert comprising a carrier enclosing a flat, rotatable wheel. The carrier comprises a front cover and a back cover. The back cover includes a hub. The hub secures the wheel to the back cover. The wheel may rotate about the hub.

Certain embodiments of the present technology relate to a rotatable wheel assembly. The rotatable wheel assembly may be comprised entirely of recyclable materials. The rotatable wheel assembly may include a wheel enclosed in a carrier. The carrier may include two cover members, a front cover member and a back cover member. The wheel may be located between the front cover member and the back cover member. At least one of the cover members may include an integrated hub. The hub may be integrated with, for example, the back cover member. The wheel may be secured by and rotate about the integrated hub. The integrated hub may extend through an axial opening in the wheel. At least one of the cover members may include a viewing window. For example, the front cover member may include a viewing window, which allows the user to view a face of the wheel.

The carrier may include a binding edge suitable for binding the rotatable wheel assembly into a magazine. The carrier may further optionally include a perforated line running parallel to the binding edge. The carrier may also include a notch; thereby making a portion of a peripheral edge of the wheel is accessible to a user.

Certain embodiments of the present technology relate to an integrated hub. The integrated hub can secure a rotatable wheel to a carrier. The integrated hub can be continuous with the carrier. In another embodiment, the integrated hub can be continuous with the rotatable wheel. The integrated hub may have a variety of forms or shapes. For example, one form may be parabolic with the base of the parabolic integrated hub remaining continuous with the carrier.

Other embodiments of the present technology relate to rotatable wheel assemblies comprising one or more integrated hubs. For example, a rotatable wheel assembly may include a carrier comprising one or more cover members and a rotatable wheel. The rotatable wheel may include two or more integrated hubs. Alternatively, at least one of the one or more cover members may include two or more integrated hubs. The two or more integrated hubs may extend through an axial opening in the wheel. The two or more integrated hubs may secure said wheel to at least one cover member. The two or more integrated hubs may have a variety of forms, shapes, and positions. For example, the two or more integrated hubs can be symmetrically or asymmetrically spaced about a central point. In one embodiment, two integrated hubs may be located approximately 180 degrees from each other.

Certain embodiments of the present technology relate to methods of making a rotatable wheel assembly. The rotatable wheel assembly may be comprised entirely of recyclable materials. The methods include cutting a blank to form at least one integrated hub, manipulating the integrated hub to receive a wheel, and enclosing the wheel in a carrier. The methods may also include aligning the integrated hub with a central axial opening in the wheel and positioning the wheel on the integrated hub such that the integrated hub extends through the central axial opening in the wheel. The carrier may be formed by folding the blank, thereby creating a front cover member and a back cover member joined by a common edge. The common edge may include a notch, thereby making a portion of a peripheral edge of the wheel is accessible to a user. The steps of the methods may be performed by a machine, such as a Machtronic Tipping Machine or a Datacard Ga-Vehren Attacherg system.

Certain embodiments of the present technology relate to methods of making a rotatable wheel assembly. The rotatable wheel assembly may be comprised entirely of recyclable materials. The methods include forming a carrier from a blank. The carrier may include at least one cover member and the cover member may include an integrated hub. The methods further include manipulating the integrated hub to receive a wheel and securing the wheel to the cover member. The carrier may include a front cover member and a back cover member. The wheel may be secured to at least one of the cover members by the integrated hub. The methods may further include cutting at least one of the cover members to form a viewing window.

### BRIEF DESCRIPTION OF SEVERAL VIEWS OF THE DRAWINGS

FIG. 1 illustrates a carrier in the “open” position and a wheel according to an embodiment of the present technology.

FIG. 2 depicts a carrier for a rotatable wheel according to an embodiment of the present technology.

FIG. 3 illustrates an assembled rotatable wheel assembly according to an embodiment of the present technology.

FIG. 4 illustrates an exemplary method of making a rotatable wheel assembly according to an embodiment of the present technology.

The foregoing summary, as well as the following detailed description of certain embodiments of the present invention, will be better understood when read in conjunction with the appended drawings. For the purpose of illustrating the invention, certain preferred embodiments are shown in the drawings. It should be understood, however, that the present invention is not limited to the arrangements and instrumentality shown in the attached drawings.

### DETAILED DESCRIPTION OF THE INVENTION

In one embodiment of the present technology, a rotatable wheel assembly may include a wheel and a carrier. The wheel may be a generally flat, round disc with a diameter of approximately 7″. The wheel may be comprised of any suitable flexible, foldable material such as paper, card stock, or paper board. For example, the wheel may be comprised of a lightweight paper such as 80 pound text stock. The wheel may include a center hole. The center hole may be, for example, 2″ in diameter. At least one face of the wheel may include information to be displayed to the user.

The wheel may be enclosed in a carrier. The carrier may include, for example, two cover members, a front cover member and a back cover member. In operation, the wheel may be sandwiched between the front cover member and the back cover member.

The carrier may be formed from a precut blank. The blank may be, for example, a generally flat, rectangular sheet measuring approximately 15½″ wide×10⅝″ high. The blank may be comprised of any suitable flexible, foldable material such as paper, card stock, or paper board. For example, the blank may be comprised of a lightweight paper such as 80 pound text stock. The blank may be folded to 7¾″ wide×10⅝″ high to form a carrier comprising two cover members. Thus, the cover members of the carrier may be hinged together at a common edge portion. The common edge portion, or closed end, may be on the right side of the carrier.

At least one of the cover members may include at least one viewing window. For example, the front cover may include a viewing window. The viewing window may be, for example, a die cut opening. In operation, a viewing window may allow the user to view a face, or a portion thereof, of the wheel. Thus, information included on the wheel may be displayed through a viewing window in one of the cover members.

At least one of the cover members may include at least one opening along the face edge. For example, there may be an opening about ½″ wide by 2¼″ high along the face edge of at least one of the cover members. The opening may be die cut. An opening along the face edge of at least one of the cover members may expose the peripheral edge of the enclosed wheel and, thus, allow visual and tactile access to the peripheral edge of the wheel. In operation, a user may rotate or spin the wheel by grasping the exposed peripheral edge of the enclosed wheel.

At least one of the cover members may include at least one hub. For example, the inside back cover may include a hub. The hub may be formed from the same material as the back cover, and further, may be an integrated feature of the inside back cover. For example, the hub may be cut from the inside back cover. The hub may be, for example, pyramid shaped and cut everywhere except at the base. The hub may be die cut. For example, the hub may be a die cut portion of the back cover, integrated into the same material as the back cover. In one embodiment, there may be a die-cut pyramid shaped paper hub at approximately ⅝″ to the right of center of the inside back cover. The top of the hub may be rounded off.

In another embodiment of the present technology, at least one of the cover members may include multiple hubs for securing the rotatable wheel to the cover member. For example, one of the cover members may include two hubs that, in the horizontal plane, extend in opposite directions. The hubs may be positioned such that when each is lifted or pushed into an upright position, the hubs may simultaneously align with an axial opening in a rotatable wheel.

In operation, a wheel may ride on the hub. In one embodiment of the present technology, a rotatable wheel may ride on a hub integrated with a carrier. The integrated hub may be, for example, formed from a portion of the back cover of a carrier. For example, an integrated hub may be formed by die-cutting a portion of the back cover of a carrier.

A rotatable wheel assembly that employs an integrated hub does not require plastic or metal grommets to affix or hold the wheel to the carrier. Furthermore, an integrated hub does not require an additional step to apply the hub to the carrier. Eliminating this additional application step not only simplifies the assembly process but also eliminates the risk of misalignment of the hub during the application step. Thus, a rotatable wheel assembly that employs an integrated hub ensures exact registration of information, indicia, or artwork printed on the face of a wheel with the viewing window.

In addition, a rotatable wheel assembly that employs an integrated hub is more durable than a rotatable wheel assembly comprising a hub that is separate and distinct feature.

The process of making a wheel assembly according to the present technology may include forming a carrier from a blank. The blank may be comprised of any suitable flexible, foldable material such as paper, card stock, or paper board. The blank may be cut to form, for example, a viewing window and a hub.

The process of assembling the wheel and carrier may involve manipulating an integrated hub such that it is capable of receiving a wheel. For example, a hub integrated with the back cover may be pushed or lifted into an upright position to receive a wheel. A wheel may then be placed over the upright hub. The front cover may be closed and the front and back covers may be bonded together with, for example, an adhesive material. At this time, a portion of the face of the wheel should be viewable through the viewing window on the front cover of the carrier.

In one embodiment of the present invention, a rotatable wheel assembly is manufactured entirely by a machine. The various desired cuts to form the precut blank may be performed by a machine. For example, a viewing window and an integrated hub, as well as any other desired cuts, may be made by a die-cutting machine. The blank may be folded prior to receiving the wheel.

The process may further include feeding a pre-cut blank into a tipping machine. The tipping machine may be any tipping machine commonly used in the art to tip printed material to another piece of printed material, for example a Machtronic double-header or single header tipping machine or a Datacard Ga-Vehren Attacher® system. For example, the pre-cut blank may be folded into a signature prior to being fed into the tipping machine. The tipping machine can open the signature and lift or push an integrated hub into an upright position to receive a wheel. The pushing or lifting of the integrated hub may be done during the feeding process. The integrated hub may be pushed or lifted by blowing air at the hub, by applying vacuum pressure to the hub, or by employing grippers to lift the integrated hub, for example. Alternatively, the tipping machine may be modified to lift the integrated hub as the signature exits the machine. For example, the tipping machine may include a protrusion aligned to contact the integrated hub and push the hub into the upright position.

The signature may be then fed to a conveyor. The conveyor can include guides that register or align the signature such that the upright, integrated hub is in position to receive a wheel. A machine, such as a pick-and-place unit, may then place the wheel over the upright hub. The machine may, for example, drop a wheel with a central axial opening onto the upright, integrated hub. The machine may then fold the hub down, thereby securing the rotatable wheel to the cover member. If necessary, the precut blank may then be folded or refolded to form a carrier.

The machine may also ensure that an appropriate portion of the wheel is showing through the viewing window or other opening in the front cover of the carrier. An adhesive or other fastener may be applied to the covers of the carrier to seal the insert. For example, glue may be applied to at least one of the covers to seal the insert.

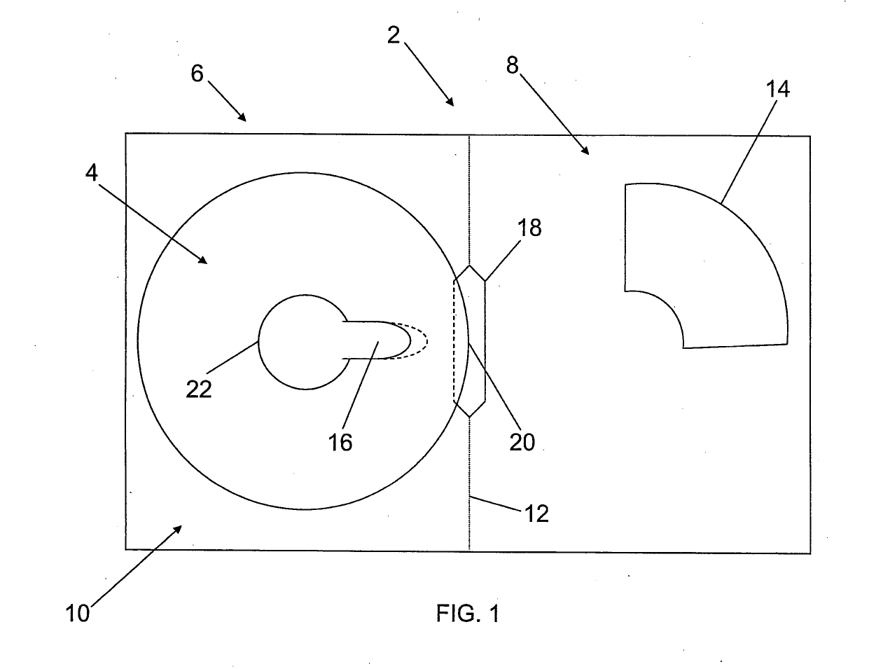

FIGS. 1-4 illustrate several views of a rotatable wheel assembly and methods of making the same according to a preferred embodiment of the present invention.

FIG. 1 illustrates a carrier 2 and wheel 4 according to an embodiment of the present technology. The carrier 2 is formed from a precut blank 6 made of any suitable flexible, foldable material such as paper, card stock, or paper board. The precut blank 6 is generally rectangular in configuration and includes, in the illustrated embodiment, a front cover member 8, a back cover member 10, and a fold line 12. The front cover member 8 includes a precut viewing window 14. The back cover member 10 includes a precut hub 16. The viewing window 14 and hub 16 may be die-cut. The precut blank 6 also includes a precut opening 18 centered along the fold line 12. The opening 18 may be die-cut. The wheel 4 includes a peripheral edge 20 and an interior edge 22 defining a hole through which hub 16 may protrude. As depicted, the wheel 4 may be a separate piece of material from the carrier 2, but may be secured to the carrier 2, for example, by the precut hub 16.

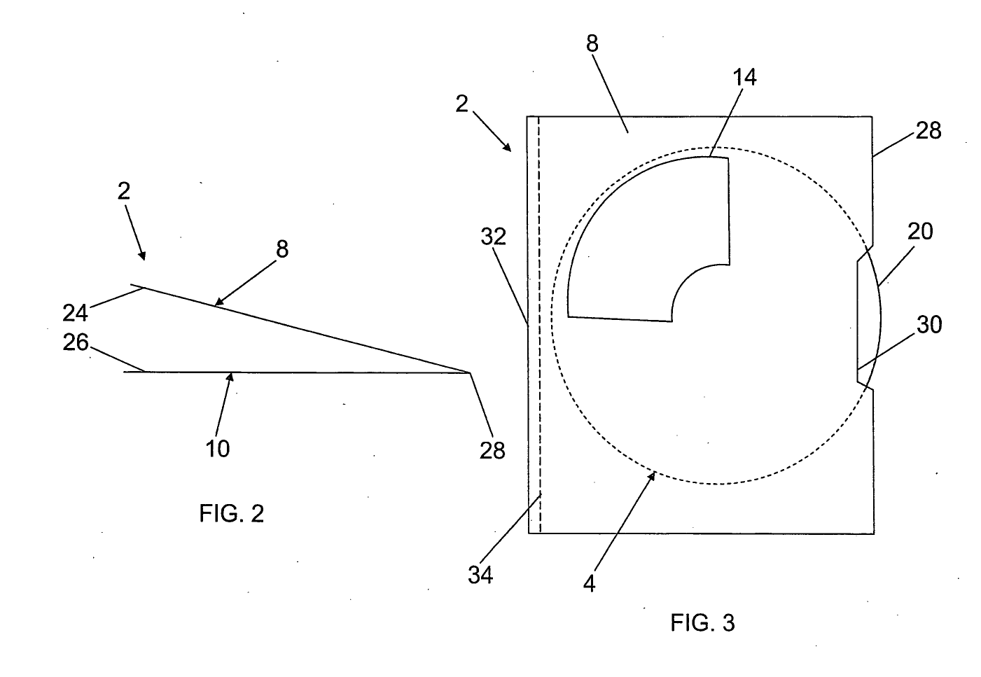

FIG. 2 illustrates a horizontal view of a carrier 2 folded along fold line 12. The precut blank 6 is folded over such that the inside face 24 of front cover member 8 is juxtaposed to the inside face 26 of back cover member 10. As can be seen in FIG. 2, front cover member 8 and back cover member 10 are joined together at a common edge 28.

FIG. 3 illustrates a view of an assembled rotatable wheel assembly according to an embodiment of the present invention. The assembly includes a carrier 2 and a rotatable wheel 4. The rotatable wheel 4 is enclosed in the carrier 2. The carrier 2 includes a front cover member 8 and a back cover member (not shown). The front cover member 8 includes a precut viewing window 14. A portion of the rotatable wheel 4 may be viewable through the viewing window 14.

The insert depicted in FIG. 3 may be formed, for example, by folding a precut blank 6 along a fold line 12, as depicted in FIG. 2. As can be seen in FIG. 3, folding a precut blank 6 along a fold line 12 (and opening 18, which is centered along fold line 12) produces a notch 30, whereby a user may grasp the peripheral edge 20 of the rotatable wheel 4. Thus, the peripheral edge 20 of the rotatable wheel 4 is accessible to the user for rotation of the rotatable wheel 4.

The rotatable wheel assembly depicted in FIG. 3 also includes a binding edge 32. In operation, the rotatable wheel assembly of the present technology may be bound into, for example, books, magazines, and saddle stitched products. Perforated line 34 allows for easy removal of the rotatable wheel assembly from the book, magazine, or other product to which it has been bound.

While the embodiment depicted in FIG. 3 has been described with reference to bound products, those of skill in the art will recognize that a rotatable wheel assembly according to the present technology may be used independently as a self contained rotatable wheel assembly.

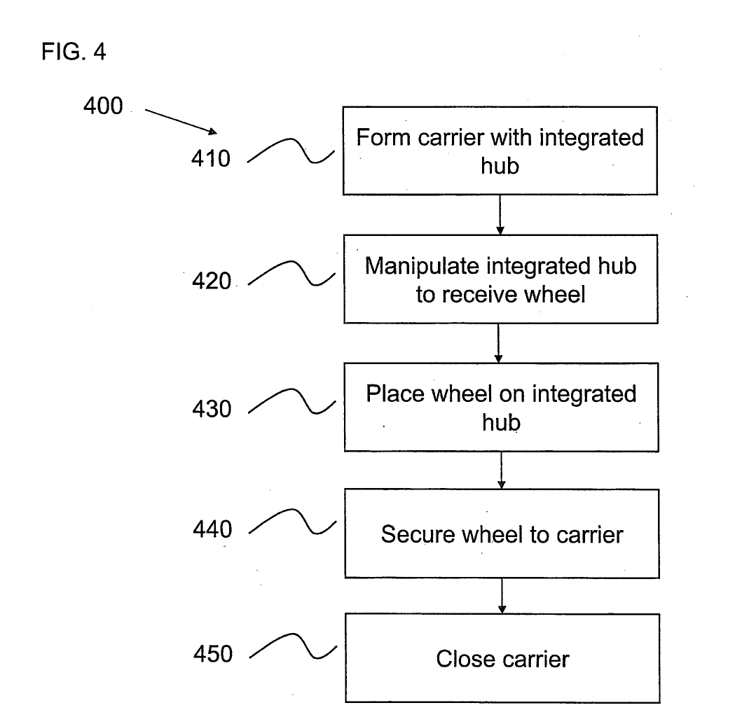

FIG. 4 illustrates an exemplary method 400 of making a rotatable wheel assembly according to an embodiment of the present technology.

The method 400 includes the following steps, which are described below in more detail. At step 410, a carrier with an integrated hub is formed. At step 420, the integrated hub is manipulated to receive a wheel. At step 430, the wheel is placed on the integrated hub. At step 440, the wheel is secured to the carrier. At step 450, the carrier is closed.

At step 410, a carrier with an integrated hub is formed. The carrier may be formed from a blank. For example, the carrier may be formed by folding the blank, thereby creating a front cover member and a back cover member joined by a common edge. The integrated hub may be formed by, for example, cutting the blank. The blank may be cut by a die-cutting process.

At step 420, the integrated hub is manipulated to receive a wheel. For example, the integrated hub may be pushed or lifted into an upright position to receive a wheel. A machine may be used to push or lift the hub into an upright position. For example, the integrated hub may be pushed or lifted by blowing air at the hub or by applying vacuum pressure to the hub.

At step 430, the wheel is placed on the integrated hub. A machine may, for example, align a wheel with a central axial opening with the upright, integrated hub. The wheel may be positioned on the integrated hub such that the integrated hub extends through the central axial opening in the wheel.

At step 440, the wheel is secured to the carrier. The integrated hub may secure the wheel to the carrier. For example, after the wheel with the central axial opening is dropped onto the upright, integrated hub, the hub may be folded down, thereby securing the wheel to the carrier.

At step 450, the carrier is closed. If necessary, the precut blank may then be folded or refolded to form a carrier. An adhesive or other fastener may be applied to the covers of the carrier to seal the insert. For example, glue may be applied to at least one of the covers to seal the insert.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A rotatable wheel assembly comprising:
a carrier carrying a flat, rotatable wheel,
wherein said carrier comprises a front cover member and a back cover member;
wherein at least one of said cover members includes an integrated hub;
wherein said wheel is secured to one of said cover members; and
wherein said wheel rotates about said hub.

2. The rotatable wheel assembly of claim 1, wherein the integrated hub extends through an axial opening in said wheel.

3. The rotatable wheel assembly of claim 2, wherein the integrated hub secures said wheel.

4. The rotatable wheel assembly of claim 1, wherein the hub is integrated with the back cover member.

5. The rotatable wheel assembly of claim 1, wherein at least one of said cover members includes a viewing window.

6. The rotatable wheel assembly of claim 1, further comprising a binding edge suitable for binding said rotatable wheel assembly into a magazine.

7. The rotatable wheel assembly of claim 6, further comprising a perforated line running parallel to said binding edge.

8. The rotatable wheel assembly of claim 1, wherein said carrier includes a notch whereby a portion of a peripheral edge of said wheel is accessible to a user.

9. The rotatable wheel assembly of claim 1, wherein at least one of said cover members includes two or more integrated hubs, wherein said two or more integrated hubs extend through an axial opening in said wheel; and wherein said two or more integrated hubs secure said wheel to said at least one cover member.

10. The rotatable wheel assembly of claim 1, wherein said rotatable wheel assembly is comprised entirely of recyclable materials.

11. A method of making a rotatable wheel assembly comprising:
cutting a blank to form at least one integrated hub;
manipulating said at least one integrated hub to receive a wheel, and enclosing said wheel in a carrier.

12. The method of claim 10, further comprising aligning said at least one integrated hub with a central axial opening in said wheel.

13. The method of claim 11, further comprising positioning said wheel on said at least one integrated hub such that said integrated hub extends through said central axial opening in said wheel.

14. The method of claim 10 wherein said carrier is formed by folding said blank, thereby creating a front cover member and a back cover member joined by a common edge.

15. The method of claim 13, wherein said common edge includes a notch whereby said wheel is accessible to a user.

16. The method of claim 10, wherein said method is performed by a machine.

17. The method of claim 10, wherein said rotatable wheel assembly is comprised entirely of recyclable materials.

18. A method of making a rotatable wheel assembly comprising:
forming a carrier from a blank, wherein said carrier includes at least one cover member, and wherein said at least one cover member includes an integrated hub;
manipulating the integrated hub to receive a wheel; and
securing the wheel to said at least one cover member.

19. The method of claim 16 wherein said carrier includes a front cover member and a back cover member.

20. The method of claim 17 wherein said back cover member includes said integrated hub.

21. The method of claim 16 further comprising cutting at least one of said cover members to form a viewing window.

22. The method of claim 16 wherein said wheel is secured to said at least one cover member by the integrated hub.

23. The method of claim 18, wherein said rotatable wheel assembly is comprised entirely of recyclable materials.
